(19) United States
(12) Patent Application Publication
(10) Pub. No.: US 2025/0199839 A1
(43) Pub. Date: Jun. 19, 2025

(54) STATE MACHINE MECHANISM FOR TARGETED CONTAINER CREATION

(71) Applicant: Red Hat, Inc., Raleigh, NC (US)

(72) Inventors: Pierre-Yves Chibon, Puteaux (FR); Leigh Griffin, Waterford (IE)

(21) Appl. No.: 18/543,332

(22) Filed: Dec. 18, 2023

(51) Int. Cl. G06F 9/455

(52) U.S. Cl. CPC G06F 9/45558; G06F 2009/4557

(57) ABSTRACT

A system and method of a state machine mechanism for targeted container creation. The method includes maintaining, in a database, a pool of available image layers and a plurality of compatibility profiles, each compatibility profile of the plurality of compatibility profiles indicates whether a respective available image layer of the pool of available image layers is compatible with other available image layers of the pool of available image layers. The method includes receiving, from a client device, a request to modify a container image including a base layer and one or more image layers. The method includes generating, based on the pool of available image layers and the plurality of compatibility profiles, a state machine for evaluating image layer compatibility for the container image. The method includes generating, by a processing device based on the state machine, a container image file that defines a modified version of the container image.

### TECHNICAL FIELD

The present disclosure relates generally to virtual machines, and more particularly, to systems and methods of a state machine mechanism for targeted container creation.

### BACKGROUND

Containerization is the packaging together of software code with all it's necessary components like libraries, frameworks, and other dependencies so that they are isolated in their own container. This is so that the software or application within the container can be moved and run consistently in any environment and on any infrastructure, independent of that environment or infrastructure's operating system. The container acts as a kind of bubble or a computing environment surrounding the application and keeping it independent of its surroundings. It is basically a fully functional and portable computing environment.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for generating a state machine mechanism for targeted container creation, according to some embodiments;

FIG. 2A is a block diagram depicting an example of the LSM system in FIG. 1, according to some embodiments.

FIG. 2B is a block diagram depicting an example of the client device of the environment in FIG. 1, according to some embodiments;

FIG. 2C is a block diagram depicting an example environment for using an LSM system, according to some embodiments;

FIG. 3 is a flow diagram depicting a method of generating a state machine mechanism for targeted container creation, according to some embodiments; and

FIG. 4 is a block diagram of an example computing device that may perform one or more of the operations described herein, in accordance with some embodiments.

### DETAILED DESCRIPTION

Containers are built upon the concept of layers. The flexibility of layers is that they can be interchanged, meaning that a user of the container can quickly swap functionality out as needed without impacting the overall container's purpose. It is often the case that a developer designs a layer to optimally execute in certain computing environments, perhaps optimized for speed, performance, and/or accuracy. The inclusion of one layer alters what other layers can be layered on top of it due to compatibility reasons. With a plurality of layers available to perform the same function (e.g., logging, error reporting, etc.), the choice of selecting the appropriate layer can often come down to environmental or deployment specific considerations such as the capability of the device (e.g., an edge device, a mesh device, a cloud-based device, a laptop, Raspberry pie, etc.). This means a one size fits all container is not appropriate and compatibility issues can emerge if not handled gracefully by the container's management control software. Consequently, the layers could execute in environments in a non-optimal fashion, which may unnecessarily consume computing resources (e.g., processing, memory, storage), power, and/or networking bandwidth of the computing environment. Thus, there is a long-felt need to solve the problems related to providing a mechanism for targeted container creation such that containers can optimally execute in a variety of different environments.

Aspects of the present disclosure address the above-noted and other deficiencies by providing a state machine mechanism for targeted container creation. The state machine mechanism (or simply, state machine) can take as an input the available layers and their compatibility profile. For each layer, a layer state machine (LSM) system creates a state map (sometimes referred to as container image file) that shows what layers are viable and what layers have compatibility issues. This allows a visual of the available combinatorial options that are available. This also provides the capability to focus on the core functionality of the container and then add layers in reverse to bring additional value to the container. It also provides the means for device specific requirements to influence the layers available—e.g., if this is deployed on an ARM device, a Raspberry Pi or an Intel NUC, it could alter what is available and compliant.

The container spec file (e.g., container image file) can be decorated with annotations (e.g., tags, labels) in the form of Boolean algebra that shows available alternative layers as a container is being designed. This shows where layers might need an AND operator or can have an OR operator or NOT operator capability naturally baked in.

For automotive applications, the state machine mechanism can be used to create targeted containers that consider the safety requirements and standards of the application. This can be integrated with a dynamic container orchestration system to adjust the container's design and layering based on the requirements of the Automotive Functional Safety (FuSa) demands at runtime. For edge devices, the state machine mechanism can be used to create targeted containers that optimize for the device's specific requirements and capabilities. The state map considers the device's hardware specifications, operating system, and available resources. Integration with a dynamic container orchestration system allows the container to adapt to changes in the device's environment over time.

Benefits of the present embodiments include, for example, the ability for a host environment to determine its compatibility in that the deployed container image file/state map can limit (or make available) specific layers based on where the container is being built and/or deployed. This allows a universal container definition, with the state machine encoded, meaning at instantiation time the state machine is navigated and the appropriate unique container is created. This also prevents a device from building and executing a container that uses layers that are not supported in the device's runtime environment; thereby avoiding the inefficient use of computing/networking resources due to crashed systems.

In an illustrative embodiment, a layer state machine (LSM) system maintains, in a database, a pool of available image layers and a plurality of compatibility profiles. Each compatibility profile of the plurality of compatibility profiles indicates whether a respective available image layer of the pool of available image layers is compatible with one or more of the other available image layers of the pool of available image layers. The LSM system receives, from a client device, a request to modify a container image that includes a base layer and one or more image layers. The LSM system generates (e.g., creates), based on the pool of available image layers and the plurality of compatibility profiles, a state machine for evaluating image layer compatibility for the container image. The LSM system generates, based on the state machine, a container image file that defines a modified version of the container image.

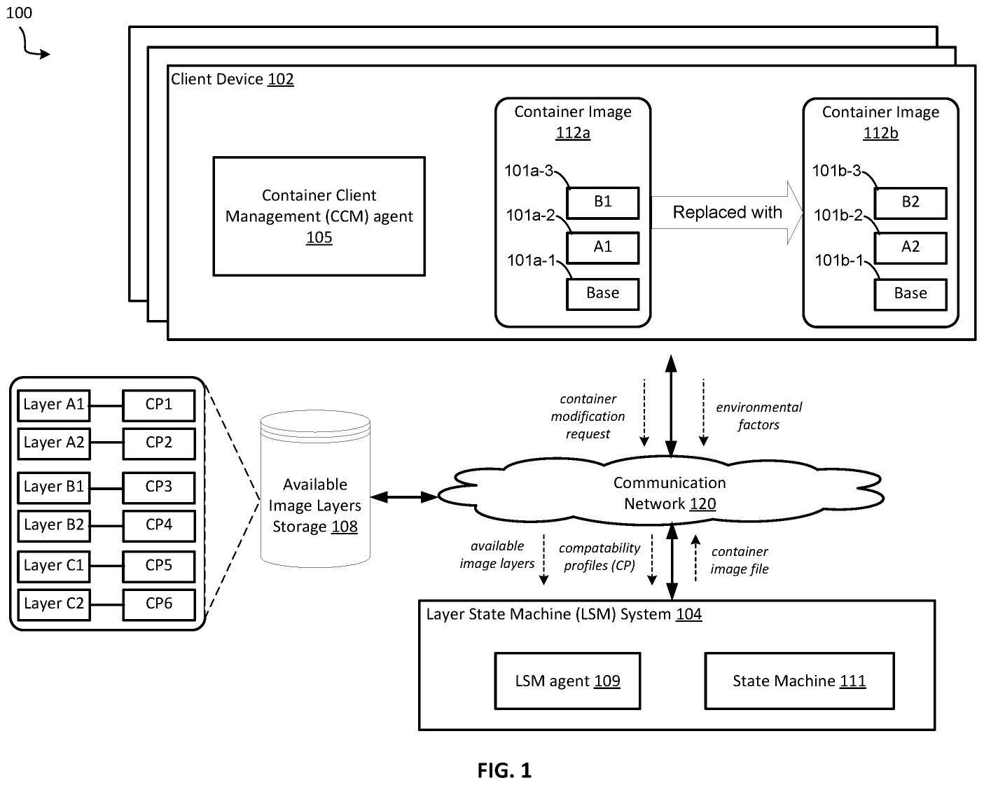

FIG. 1 is a block diagram depicting an example environment for generating a state machine mechanism for targeted container creation, according to some embodiments. The environment 100 includes a layer state machine (LSM) system 104, one or more client devices 102, and an available image layers storage 108 that are each communicably coupled together via a communication network 120. The LSM system 104 includes and/or executes an LSM agent 109 and a state machine 111. Each client device 102 includes and/or executes a container client management (CCM) agent 105, and container images 112 (e.g., a container image 112a, and a container image 112b.)

The communication network 120 may be a public network (e.g., the internet), a private network (e.g., a local area network (LAN) or wide area network (WAN)), or a combination thereof. In one embodiment, communication network 120 may include a wired or a wireless infrastructure, which may be provided by one or more wireless communications systems, such as wireless fidelity (Wi-Fi) connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

The CCM agent 105 launches the container images 112 so that they execute on the processor of the client device 102. As discussed here, the CCM agent 105 may either stop (e.g., tear down) the container image 112a from running and then execute the container image 112b, or replace an image layer of the container image 112a in real-time such that the container image 112a becomes container image 112b without stopping the container image 112a. This latter scenario helps to ensure that the client device 102 continues to receive uninterrupted service from the container images 112.

A container image 112 includes one or more unique container layers 101 that are stacked on top of one another, where the bottom layer is referred to as the parent layer or the base layer. As shown in FIG. 1, container image 112a includes an image layer 101a-1 (“base”), an image layer 101a-2 (“A1”), and an image layer 101a-3 (“B1”); and container image 112b includes an image layer 101b-1 (“base”), an image layer 101b-2 (“B1”), and an image layer 101b-3 (“B2”), where each image layer may collectively be referred to as image layers 101. In some embodiments, a container image 112 may include any number of image layers 101.

One or more developers create each of the image layers 101 using a computing device and store (e.g., upload) the image layers 101 in the available image layer storage 108 via the communication network 120. An image layer 101 may include application code, libraries, system tools, dependencies, configuration/setting files, environment variables, runtimes, and other files and/or binary files needed to make an application execute. An image layer 101 may be configured to provide a service. Non-limiting examples of a service include a database or repository service, a compute service, a file system service, a cloud storage service, an application service, a network service, a network traffic management service, a cybersecurity service, etc.

The one or more developers also store, in the available image layer storage 108 and for each image layer 101, a corresponding capability profile (CP) that indicates a first set of other image layers 101 (e.g., other available image layers) that are not compatible with the particular image layer 101 and a second set of other image layers 101 that are compatible with the particular image layer 101. As shown in FIG. 1, image layer A1 is associated with CP1, image layer A2 is associated with CP2, image layer B1 is associated with CP3, image layer B2 is associated with CP4, image layer C1 is associated with CP5, and image layer C2 is associated with CP6. A first image layer 101 is not compatible with a second image layer 101, if executing a container image 112 that includes both image layers 101 causes the computing device that executes the container image 112 to enter an errored state (e.g., crash) and/or prevents the container image 112 from being able to provide the first service associated with the first image layer 101 and/or provide the second service associated with the second image layer 101 to an end-user. The one or more developers may derive the CP for a given image layer based on “smoke” testing, compatibility testing, version compatibility testing, and/or statically deriving the CP. The one or more developers may create a separate file that indicates the CP for the image layer and/or add the CP directly to the image layer 101 using annotations, tag, and/or labels.

A container image 112 is a standard unit of software that packages up code and one or more (e.g., or all) of its dependencies so that a software application may run efficiently and reliably from one computing environment to another. That is, a container image 112 is a lightweight, standalone, executable package of software that includes everything (e.g., code, runtime, dependencies, system tools, configuration files, system libraries and settings, etc.) needed to run an application. The container image 112 is an unchangeable, static file that includes executable code that allows the container image 112 to run as an isolated process. Specifically, each container image 112 is allocated a set of resources (e.g., memory, processing, storage, and/or network bandwidth, etc.) that are isolated from the resources that are allocated to other container images 112 executing on the same computing device, but the container images 112 are still allowed to communicate with each other through communication channels.

A container image 112 that includes multiple layers 101 may provide a variety of different types of services according to the layers 101, wherein each layer uses (e.g., allocates, reserves) a particular set of computing resources and a particular amount of each computing resource (e.g., memory, processing, storage, and/or network bandwidth, etc.) of the computing environment that executes the container image 112. For example, a first layer (e.g., layer 101a-1) of container image 112a may correspond to one or more binary files that use 1 gigabyte (GB) of data storage and 100 megabytes (MB) of memory of the computing environment (e.g., the resources of client device 102), and a second layer (e.g., layer 101a-2) of the container image 112a may correspond to one or more binary files that use 0.5 gigabyte (GB) of data storage and 50 megabytes (MB) of memory of the computing environment, and a third layer (e.g., layer 101a-3) of container image 112a may correspond to one or more binary files that use 200 megabytes (MB) of memory and no amount of data storage of the computing environment.

The CCM agent 105 of the client device 102 and the LSM agent 109 of the LSM system 104 are each configured to build the container images 112 based on one or more application files (e.g., source code, executable code, libraries, dependencies, configuration files, container image file, test documents, container file, etc.) and/or one or more image layers that are pre-built and stored in a database (e.g., available image layers storage 108). In some embodiment, the agents (e.g., CCM agent 105 and/or the LSM agent 109) may be configured to make changes (e.g., writing new files/data, modifying existing files/data, deleting files, etc.) to a running container image (e.g., container image 112) by writing to the writable container layer. In some embodiments, the agents may be configured to generate the container image 112 by adding a writable layer (sometimes referred to as, “container layer”) on top of the underlying layers of a container image 112 to rebase the container image 112. For example, the LSM agent 109 may retrieve a container image 112 and one or more image layers 101 from the available image layers storage 108 and add the one or more image layers on top of the layers of the container image 112. In some embodiments, the agents may be configured to delete the container image 112 by deleting the writable layer, but where the underlying image remains unchanged.

The LSM system 104 and client device 102 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

Still referring to FIG. 1, the LSM system 104 maintains, in the available image layers storage 108, a pool of available image layers and a plurality of compatibility profiles. Each compatibility profile of the plurality of compatibility profiles indicates whether a respective available image layer of the pool of available image layers is compatible with one or more of the other available image layers of the pool of available image layers. The LSM system 104 receives a request from the client device 102, where the request is to modify a container image (e.g., container image 112a) that includes a base layer (e.g., 101a-1) and one or more image layers (e.g., 101a-2, 101a-3). The LSM system 104 generates (e.g., creates), based on the pool of available image layers and the plurality of compatibility profiles, a state machine 111 for evaluating image layer compatibility for the container image. The LSM system 104 generates, based on the state machine 111, a container image file that defines a modified version of the container image.

Although FIG. 1 shows only a select number of computing devices (e.g., LSM system 104 and client device 102), the environment 100 may include any number of computing devices that are interconnected in any arrangement to facilitate the exchange of data between the computing devices.

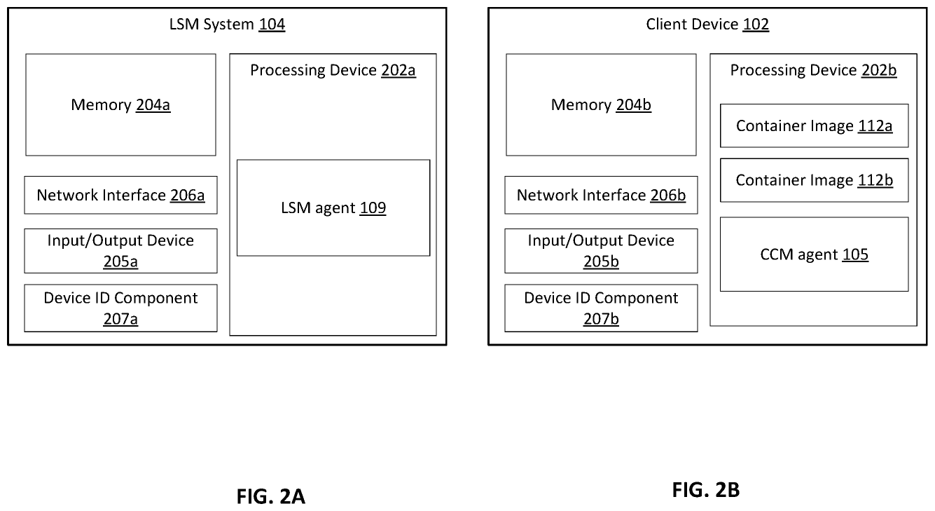

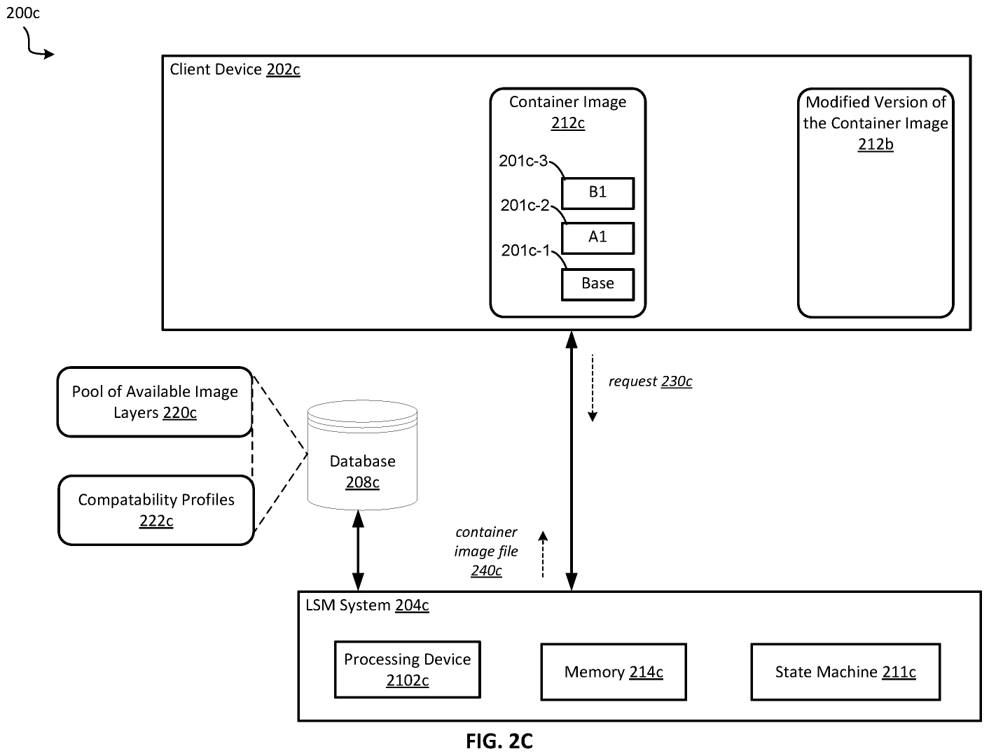

FIG. 2A is a block diagram depicting an example of the LSM system 104 in FIG. 1, according to some embodiments. While various devices, interfaces, and logic with particular functionality are shown, it should be understood that the LSM system 104 includes any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The LSM system 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the LSM system 104. In some embodiments, the processing device 202a and the memory 204a form various processing devices and/or circuits described with respect to the LSM system 104. The instructions include code from any suitable computer programming language such as, but not limited to, C, C++, C#, Java, JavaScript, VBScript, Perl, HTML, XML, Python, TCL, and Basic.

The processing device 202a executes the LSM agent 109 which may be configured to maintain, in a database (e.g., available image layers storage 108), a plurality of associations between a pool of available image layers 101 and a plurality of compatibility profiles. Each association is between a single image layer 101 of the pool of available image layers and a single compatibility profile of the plurality of compatibility profiles. Each compatibility profile of the plurality of compatibility profiles indicates whether its corresponding available image layer 101 is compatible with any of the other available image layers 101 of the pool of available image layers 101.

The LSM agent 109 may be configured to receive a request (e.g., container modification request) from the client device 102, where the request is to modify a container image 112 that includes a base layer (e.g., 101a-1) and one or more image layers (e.g., 101a-2, 101a-3). The LSM agent 109 may be configured to generate, based on the pool of available image layers and the plurality of compatibility profiles, the state machine 111 for evaluating image layer compatibility for container images 112. The LSM agent 109 may be configured to generate, based on the state machine 111, a container image file that defines a modified version of the container image. For example, the request may be to modify container image 112a (currently running) to turn it into and/or replace it with container image 112b.

The LSM agent 109 may be configured to send (e.g., transmit), to the client device 102, the container image file to be used by the client device 102 to modify (e.g., swap and/or add image layers) the container image 112a that is executing on the client device 102. The LSM agent 109 may be configured to send, to the client device 102, the container image file to be used by the client device 102 to generate a different container image (container image 112b). In some embodiments, the sending of the container image file causing the CCM agent 105 of the client device 102 to either stop (e.g., tear down) the container image 112a that is currently running and then execute the container image 112b, or replace an image layer 101 of the currently-running container image 112a in real-time such that the container image 112a becomes container image 112b without stopping the container image 112a. This latter scenario helps to ensure that the client device 102 continues to receive uninterrupted service from the container images 112.

The request may be to replace a first image layer (e.g., A1) of the one or more image layers with a different image layer (e.g., A2), where the second image layer of the one or more image layers 101 of the container image 112a is stacked above the first image layer of the one or more image layers of the container image 112a. In this embodiment, the LSM agent 109 may be configured to determine, based on the state machine 111, an incompatibility between the second image layer 101 (e.g., B1) and the different image layer 101 (A2). The LSM agent 109 identifies, based on the state machine 111, an available image layer 101 (e.g., B2) from the pool of available image layers that is compatible with the different image layer 101 (e.g., A2). The LSM agent 109 defines, in the container image file, the modified version of the container image (e.g., container image 112b) by replacing the first image layer (e.g., A1) with the different image layer (e.g., A2) and the second image layer (e.g., B1) with the available image layer (e.g., B2).

For example, the first image layer might be a database (DB) layer such as MongoDB and the second image layer might be an Application Programming Interface (API) binding layer to use MongoDB. Therefore, swapping the first image layer for a different DB layer (e.g., Redis, OrientDB, RethinkDB, etc.) would make the second image layer incompatible with the different DB layer. Therefore, the LSM agent 109 can detect this incompatibility and proceed to swap (e.g., replace) the second image layer with an alternate image layer that is compatible with the different DB layer.

The request may be to add an additional image layer to the container image. In this embodiment, the LSM system 104 may be configured to identify, based on the state machine 111, a first available image layer from the pool of available image layers that is compatible with the one or more image layers of the container image. The LSM system 104 may be configured to select the first available image layer from the pool of available image layers responsive to identifying the first available image layer. The LSM system 104 defines, in the container image file, the modified version of the container image to add the first available image layer to the container image. That is, the LSM system 104 defines the modified version of the container image by including data (e.g., source code, executable code, libraries, dependencies, etc.) in the container image file such that a computing device (e.g., LSM system 104, client device 102) can use the container image file to generate the modified version of the container image.

For example, the request could indicate that the additional layer should be a MongoDB layer, and in response, the LSM agent 109 identifies the one or more available layers from the pool of available layers in the available image layers storage 108 that provide the MongoDB service. Each available image layer is configured to demand a different set of resources and/or different amount/quantity of resources from the computing device (e.g., client device 102) that is executing the container, so to provide a particular/different quality of the MongoDB service.

The LSM agent 109 may be configured to determine, based on the state machine 111, an incompatibility between the additional image layer indicated in the request and at least one image layer of the one or more image layers of the container image 112. In response, the LSM agent 109 may reject the request to add the additional image layer to the container image 112, so to prevent the client device 102 from executing a container image 112 that includes the incompatible image layers. The LSM agent 109 may also generate a message that explains how (e.g., due to security issues, privilege issues, and/or resource issues) the additional image layer indicated in the request is incompatible with the at least one image layer of the one or more image layers of the container image 112. The LSM agent 109 sends the messages to the client device 102 for the client device 102 to present on a display.

The LSM agent 109 may be configured to obtain one or more environmental factors that are associated with the client device 102. The client device 102 may execute in any of a variety of different types of environments including, for example, a cloud-based network, an edge network, an Internet of Things (IoT) network, a mesh network, an automobile network, or the like. The one or more environmental factors may include at least one of a device type (e.g., Raspberry pie, laptop, edge device, IoT device, mesh device), an application type (e.g., operating system type), a security level and/or restrictions, one or more resource types (e.g., processing device, memory, etc.), and/or an indication of an amount of available resources of the client device 102.

The LSM agent 109 may be configured to generate the container image file that defines the modified version of the container image 112 based on the state machine 111 and the one or more environmental factors.

In some embodiments, the container image file includes a plurality of modified versions of the container image 112. In some embodiments, the container image file includes a plurality of optional images layers of the plurality of modified versions of the container image are defined using Boolean logic (e.g., AND, OR, NOT).

The LSM system 104 includes a network interface 206a configured to establish a communication session with a computing device for sending and receiving data over the communication network 120 to the computing device. Accordingly, the network interface 206A includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the LSM system 104 includes a plurality of network interfaces 206a of different types, allowing for connections to a variety of networks, such as local area networks (public or private) or wide area networks including the Internet, via different sub-networks.

The LSM system 104 includes an input/output device 205a configured to receive user input from and provide information to a user. In this regard, the input/output device 205a is structured to exchange data, communications, instructions, etc. with an input/output component of the LSM system 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the LSM system 104, such as a built-in display, touch screen, microphone, etc., or external to the housing of LSM system 104, such as a monitor connected to LSM system 104, a speaker connected to LSM system 104, etc., according to various embodiments. In some embodiments, the LSM system 104 includes communication circuitry for facilitating the exchange of data, values, messages, and the like between the input/output device 205a and the components of the LSM system 104. In some embodiments, the input/output device 205a includes machine-readable media for facilitating the exchange of information between the input/output device 205a and the components of the LSM system 104. In still another embodiment, the input/output device 205a includes any combination of hardware components (e.g., a touchscreen), communication circuitry, and machine-readable media.

The LSM system 104 includes a device identification component 207a (shown in FIG. 2A as device ID component 207a) configured to generate and/or manage a device identifier associated with the LSM system 104. The device identifier may include any type and form of identification used to distinguish the LSM system 104 from other computing devices. In some embodiments, to preserve privacy, the device identifier may be cryptographically generated, encrypted, or otherwise obfuscated by any device and/or component of LSM system 104. In some embodiments, the LSM system 104 may include the device identifier in any communication (e.g., container image file, rejection messages, etc.) that the LSM system 104 sends to a computing device.

The LSM system 104 includes a bus (not shown), such as an address/data bus or other communication mechanism for communicating information, which interconnects the devices and/or components of LSM system 104, such as processing device 202a, network interface 206a, input/output device 205a, and device ID component 207a.

In some embodiments, some or all of the devices and/or components of LSM system 104 may be implemented with the processing device 202a. For example, the LSM system 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of the client device of the environment in FIG. 1, according to some embodiments. While various devices, interfaces, and logic with particular functionality are shown, it should be understood that the client device 102 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The client device 102 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2a, but with respect to devices and/or components of the client device 102 instead of devices and/or components of the LSM system 104.

The memory 204b of processing device 202b stores data and/or computer instructions/code for facilitating at least some of the various processes described herein. The memory 204b includes identical or nearly identical functionality as memory 204a in FIG. 2A, but with respect to devices and/or components of the client device 102 instead of devices and/or components of the LSM system 104.

The processing device 202b may be configured to execute container images 112 (e.g., container image 112a, container image 112b). Each container image 112 includes one or more unique container layers 101 that are stacked on top of one another, where the bottom layer is referred to as the parent layer or the base layer. For example, container image 112a includes an image layer 101a-1 (“base”), an image layer 101a-2 (“A1”), and an image layer 101a-3 (“B1”); and container image 112b includes an image layer 101b-1 (“base”), an image layer 101b-2 (“B1”), and an image layer 101b-3 (“B2”), where each image layer may collectively be referred to as image layers 101. The processing device 202b may be configured to execute a single container image 112 (e.g., container image 112a or container image 112b) at a time or simultaneously execute both container images 112 at the same time.

The processing device 202b executes the CCM agent 105. The CCM agent 105 may be configured to transmit a request (e.g., container modification request) to the LSM system 104, where the request is to modify container image 112a. In some embodiments, the request is to replace an image layer of the one or more image layers of the container image 112a with a different image layer. In some embodiments, the request is to add an additional image layer to the container image 112a.

The CCM agent 105 may be configured to receive, from the LSM system 104, a container image file. The CCM agent 105 may use the container image file to modify the container image 112a. For example, the CCM agent 105 may use the container image file to generate container image 112b. Alternatively, the CCM agent 105 may use the container image file to rebase the container image 112a such that the container image 112a includes the same layers (and functionality) as container image 112b. In some embodiments, rebasing the container image 112a is performed without causing an interruption to the one or more services that are provided by the container image 112a.

The client device 102 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the client device 102 instead of devices and/or components of the LSM system 104.

The client device 102 includes an input/output device 205b configured to receive user input from and provide information to a user. In this regard, the input/output device 205b is structured to exchange data, communications, instructions, etc. with an input/output component of the client device 102. The input/output device 205b includes identical or nearly identical functionality as input/output device 205a in FIG. 2A, but with respect to devices and/or components of the client device 102 instead of devices and/or components of the LSM system 104.

The client device 102 includes a device identification component 207b (shown in FIG. 2B as device ID component 207b) configured to generate and/or manage a device identifier associated with the client device 102. The device ID component 207b includes identical or nearly identical functionality as device ID component 207a in FIG. 2A, but with respect to devices and/or components of the client device 102 instead of devices and/or components of the LSM system 104.

The client device 102 includes a bus (not shown), such as an address/data bus or other communication mechanism for communicating information, which interconnects the devices and/or components of the client device 102, such as processing device 202b, network interface 206b, input/output device 205b, and device ID component 207b.

In some embodiments, some or all of the devices and/or components of client device 102 may be implemented with the processing device 202b. For example, the client device 102 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment for using an LSM system, according to some embodiments. The LSM system 204c (e.g., LSM system 104 in FIG. 1) includes a memory 214c; and a processing device 202c that is operatively coupled to the memory. The processing device 202c is configured to maintain, in a database 208c (e.g., available image layers storage 108), a pool of available image layers 220c and a plurality of compatibility profiles 222c. Each compatibility profile of the plurality of compatibility profiles 222c indicates whether a respective available image layer of the pool of available image layers 220c is compatible with one or more of the other available image layers of the pool of available image layers 220c. The processing device 202c is configured to receive, from a client device 203c, a request 230 to modify a container image 212c that includes a base layer 210c-1 and one or more image layers (e.g., 201c-2, 201c-3). The processing device 202c is configured to generate (e.g., create), based on the pool of available image layers 220c and the plurality of compatibility profiles 222c, a state machine 211c for evaluating image layer compatibility for the container image 212c. The processing device 202c is configured to generate, based on the state machine 211c, a container image file 240c that defines a modified version of the container image 212b.

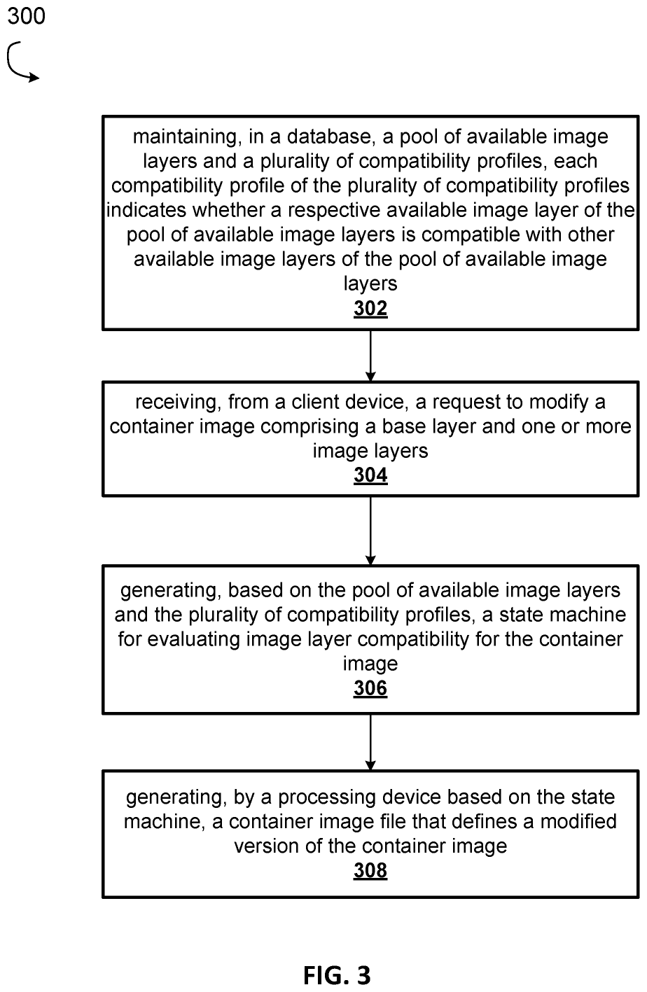

FIG. 3 is a flow diagram depicting a method of generating a state machine mechanism for targeted container creation, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 300 may be performed by one or more layer state machine systems, such as LSM system 104 in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of maintaining, in a database, a pool of available image layers and a plurality of compatibility profiles, each compatibility profile of the plurality of compatibility profiles indicates whether a respective available image layer of the pool of available image layers is compatible with other available image layers of the pool of available image layers. The method 300 includes the block 304 of receiving, from a client device 102, a request to modify a container image including a base layer and one or more image layers. The method 300 includes the block 306 of generating, based on the pool of available image layers and the plurality of compatibility profiles, a state machine for evaluating image layer compatibility for the container image. The method 300 includes the block 308 of generating, by a processing device based on the state machine, a container image file that defines a modified version of the container image.

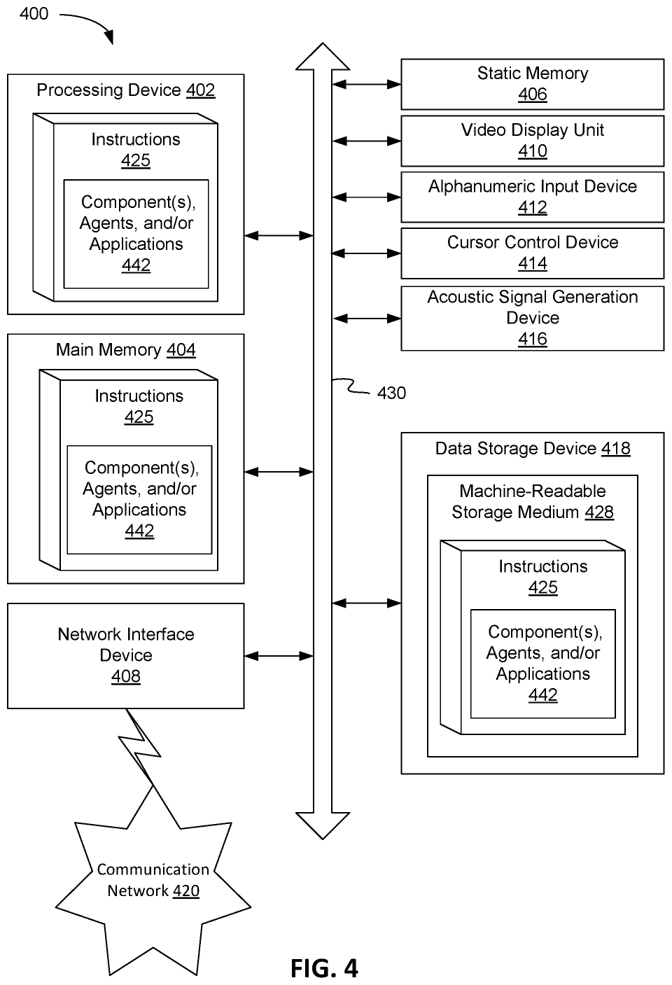

FIG. 4 is a block diagram of an example computing device 400 that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components/agents/applications 442 (e.g., CCM agent 105, LSM agent 109, state machine 111, container image 112a, and container image 112b) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “maintaining,” “receiving,” “generating,” “sending,” “executing,” “detecting,” “identifying,” “defining,” “rejecting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the embodiments of the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the embodiments of the present disclosure are not to be limited to the details given herein, but may be modified within the scope and equivalents of the appended claims.

What is claimed is:

1. A method comprising:
maintaining, in a database, a pool of available image layers and a plurality of compatibility profiles, each compatibility profile of the plurality of compatibility profiles indicates whether a respective available image layer of the pool of available image layers is compatible with other available image layers of the pool of available image layers;
receiving, from a client device, a request to modify a container image comprising a base layer and one or more image layers;
generating, based on the pool of available image layers and the plurality of compatibility profiles, a state machine for evaluating image layer compatibility for the container image; and
generating, by a processing device based on the state machine, a container image file that defines a modified version of the container image.

2. The method of claim 1, wherein the container image is executing on the client device, and further comprising:
sending, to the client device, the container image file to be used by the client device to modify the container image that is executing on the client device; or
sending, to the client device, the container image file to be used by the client device to generate a different container image.

3. The method of claim 2, wherein the container image provides a service to the client device, and wherein sending, to the client device, the container image file to be used by the client device to modify the container image that is executing on the client device is further without causing an interruption to the service.

4. The method of claim 1, wherein a second image layer of the one or more image layers of the container image is stacked above a first image layer of the one or more image layers of the container image, wherein the request is to replace the first image layer of the one or more image layers with a different image layer, and further comprising:
determining, based on the state machine, an incompatibility between the second image layer and the different image layer;
identifying, based on the state machine, an available image layer from the pool of available image layers that is compatible with the different image layer; and
defining, in the container image file, the modified version of the container image by replacing the first image layer with the different image layer and the second image layer with the available image layer.

5. The method of claim 1, wherein the request is to add an additional image layer to the container image, and further comprising:
identifying, based on the state machine, a first available image layer from the pool of available image layers that is compatible with the one or more image layers of the container image; and
defining, in the container image file, the modified version of the container image to add the first available image layer to the container image.

6. The method of claim 5, further comprising:
determining, based on the state machine, an incompatibility between the additional image layer indicated in the request and at least one image layer of the one or more image layers of the container image; and
rejecting the request to add the additional image layer to the container image.

7. The method of claim 1, further comprising:
obtaining one or more environmental factors associated with the client device, wherein the one or more environmental factors indicate at least one of a device type, a security level, or available resources of the client device.

8. The method of claim 7, wherein generating, based on the state machine, the container image file that defines the modified version of the container image is further based on the one or more environmental factors.

9. The method of claim 1, wherein the container image file comprises a plurality of modified versions of the container image.

10. The method of claim 9, wherein a plurality of optional images layers of the plurality of modified versions of the container image are defined using Boolean logic.

11. A system comprising:
a memory; and
a processing device, operatively coupled to the memory, to:
maintain, in a database, a pool of available image layers and a plurality of compatibility profiles, each compatibility profile of the plurality of compatibility profiles indicates whether a respective available image layer of the pool of available image layers is compatible with other available image layers of the pool of available image layers;
receive, from a client device, a request to modify a container image comprising a base layer and one or more image layers;
generate, based on the pool of available image layers and the plurality of compatibility profiles, a state machine for evaluating image layer compatibility for the container image; and
generate, based on the state machine, a container image file that defines a modified version of the container image.

12. The system of claim 11, wherein the container image is executing on the client device, and further comprising:
send, to the client device, the container image file to be used by the client device to modify the container image that is executing on the client device; or
send, to the client device, the container image file to be used by the client device to generate a different container image.

13. The system of claim 12, wherein the container image provides a service to the client device, and wherein to send, to the client device, the container image file to be used by the client device to modify the container image that is executing on the client device is further without causing an interruption to the service.

14. The system of claim 11, wherein a second image layer of the one or more image layers of the container image is stacked above a first image layer of the one or more image layers of the container image, wherein the request is to replace the first image layer of the one or more image layers with a different image layer, and wherein the processing device is further to:
determine, based on the state machine, an incompatibility between the second image layer and the different image layer;
identify, based on the state machine, an available image layer from the pool of available image layers that is compatible with the different image layer; and
define, in the container image file, the modified version of the container image by replacing the first image layer with the different image layer and the second image layer with the available image layer.

15. The system of claim 11, wherein the request is to add an additional image layer to the container image, and wherein the processing device is further to:
identify, based on the state machine, a first available image layer from the pool of available image layers that is compatible with the one or more image layers of the container image; and
define, in the container image file, the modified version of the container image to add the first available image layer to the container image.

16. The system of claim 15, wherein the processing device is further to:
determine, based on the state machine, an incompatibility between the additional image layer indicated in the request and at least one image layer of the one or more image layers of the container image; and
reject the request to add the additional image layer to the container image.

17. The system of claim 11, wherein the processing device is further to:
obtain one or more environmental factors associated with the client device, wherein the one or more environmental factors indicate at least one of a device type, a security level, or available resources of the client device.

18. The system of claim 17, wherein generating, based on the state machine, the container image file that defines the modified version of the container image is further based on the one or more environmental factors.

19. The system of claim 18, wherein at least one of:
the container image file comprises a plurality of modified versions of the container image, or
a plurality of optional images layers of the plurality of modified versions of the container image are defined using Boolean logic.

20. A non-transitory computer-readable medium storing instructions that, when execute by a processing device, cause the processing device to:
maintain, in a database, a pool of available image layers and a plurality of compatibility profiles, each compatibility profile of the plurality of compatibility profiles indicates whether a respective available image layer of the pool of available image layers is compatible with other available image layers of the pool of available image layers;
receive, from a client device, a request to modify a container image comprising a base layer and one or more image layers;
generate, by the processing device based on the pool of available image layers and the plurality of compatibility profiles, a state machine for evaluating image layer compatibility for the container image; and
generate, based on the state machine, a container image file that defines a modified version of the container image.
